(19) United States
(12) Patent Application Publication
(10) Pub. No.: US 2008/0128374 A1
(43) Pub. Date: Jun. 5, 2008

(54) OVERHEAD TRAVELING AND TRANSPORTING APPARATUS

(75) Inventor: Senzo Kyutoku, Ise-shi (JP)

Correspondence Address: YOUNG & THOMPSON, 209 Madison Street, Suite 500, ALEXANDRIA, VA, 22314, US

(73) Assignee: ASYST TECHNOLOGIES JAPAN, INC., MIE (JP)

(21) Appl. No.: 11/947,137

(22) Filed: Nov. 29, 2007

(30) Foreign Application Priority Data
Nov. 30, 2006 (JP) 2006-323197

(51) Int. Cl. B66C 13/08

(52) U.S. Cl. 212/276

(57) ABSTRACT

An overhead traveling and transporting system includes a transporting carriage traveling along a track. The carriage has a gripping mechanism to grip an object, a hoisting mechanism to move down the gripping mechanism to a load port for the object, and a sensor emitting a light beam within a pseudo plane surface and receiving a reflection thereof. The system also has: a device for monitoring an obstacle existing in an emission direction of the emitted light beam, based on the reflected light; and a selecting device for establishing one condition that the obstacle existing forward in the traveling direction is monitored if the transporting carriage is traveling and establishing another condition that the obstacle existing downward from the transporting carriage is monitored if the gripping mechanism is moved down, by selecting the direction of emission and/or selecting an area of monitoring by the monitoring device.

### BACKGROUND OF THE INVENTION

1. Field of the Invention

The present invention relates to an overhead traveling and transporting apparatus for holding a transported object in such a manner that the apparatus can move up and down the transported object, and for traveling along a track which is installed on or near the ceiling in a factory or the like. Here, the “transported object” means a product, an intermediate product, a part, an article, a work, a partly-finished good, a good or the like, or means a box or container for containing such a product or the like, which has been transported or is to be transported by the apparatus.

2. Description of the Related Art

In a manufacturing facility for the semiconductor device for example, the overhead traveling and transporting apparatus is utilized. This apparatus is provided with a transporting carriage. The transporting carriage travels between various semiconductor manufacturing apparatuses by traveling along a track or rail installed on or near the ceiling, while the transporting carriage holds or grips a FOUP (Front-Opening Unified Pod), which accommodates semiconductor wafers therein, by a gripper capable of moving up and down the FOUP. The main body of the semiconductor manufacturing apparatus is disposed beneath and in the vicinity of the track such that a load port of the semiconductor manufacturing apparatus is just below the track. Therefore, the transporting carriage stops above the load port of the semiconductor manufacturing apparatus, on which the FOUP to be transported from now is loaded or put, then moves down the gripper so as to grip the FOUP, and then moves up the gripper, so that the transporting carriage can retrieve or take up the FOUP. The transporting carriage, which has retrieved the FOUP, travels to another semiconductor manufacturing apparatus for performing a next process. On the other hand, the transporting carriage stops above the load port of the semiconductor manufacturing apparatus, and then moves down the gripper which is currently gripping the FOUP, so that the transporting carriage can load the FOUP onto the load port.

In the above described transporting carriage of the overhead traveling and transporting apparatus, a forward monitoring sensor is equipped at a front surface in the traveling direction, which irradiates a light beam forward in the traveling direction and receives the reflection light thereof, in order to detect an obstacle forward in the traveling direction at the time of traveling along the track, as disclosed in Japanese Patent Application Laid Open Publication No. 2002-132347 (in particular FIG. 2 thereof). On the other hand, in the transporting carriage, a downward monitoring sensor is equipped, which irradiates a light beam for scanning beneath the transporting carriage and receives the reflection light thereof, in order to detect an obstacle beneath the transporting carriage, as disclosed in Japanese Patent Application Laid Open Publication No. 2001-213588 (in particular FIG. 1 thereof). By these, it is possible to prevent the gripper from contacting with an obstacle within the moving up and down path of the gripper, at the time of taking up the FOUP from the load port of the semiconductor manufacturing apparatus, and/or at the time of loading the FOUP onto the load port.

### SUMMARY OF THE INVENTION

As described above, in the transporting carriage of the overhead traveling and transporting apparatus, quite a number of sensors, such as the forward monitoring sensor for detecting the obstacle forward in the traveling direction, the downward monitoring sensor for detecting the obstacle beneath the transporting carriage and the like, are required to be equipped. Thus, there arises such a problem that the structure of the transporting carriage becomes complicated and the cost is increased.

It is therefore an object of the present invention to provide an overhead traveling and transporting apparatus, which can detect an obstacle forward in the traveling direction of the transporting carriage and an obstacle downward from the transporting carriage at relatively low cost.

The above object of the present invention can be achieved by an overhead traveling and transporting system comprising: a track installed on or near a ceiling; a transporting carriage for traveling along and being guided by said track having (i) a gripping mechanism adapted to grip a transported object, (ii) a hoisting mechanism adapted to move down said gripping mechanism to a load port for the transported object, and (iii) a sensor for emitting a light beam within a pseudo plane surface, which is perpendicular and in parallel with a traveling direction of said transporting carriage, and for receiving a reflection light of the emitted light beam; a monitoring device for monitoring an obstacle existing in a direction of emission of the emitted light beam, on the basis of the reflection light received by said sensor; and a selecting device for (i) establishing one condition that the obstacle existing forward in the traveling direction is monitored by said monitoring device if said transporting carriage is traveling and (ii) establishing another condition that the obstacle existing downward from said transporting carriage is monitored by said monitoring device if said gripping mechanism is moved down, by selecting the direction of emission and/or selecting an area of monitoring by said monitoring device.

According to the present invention, the selecting device controls the sensor as following. Namely, in case that the transporting carriage is traveling, the light beam is emitted forward in the traveling direction of the transporting carriage. In case that the gripping mechanism is moved down, the light beam is emitted downward from the transporting carriage. In either case, the monitoring device monitors in the direction of emission. Alternatively, the light beam of the sensor is consistently emitted in directions including the forward traveling direction of the transporting carriage and the downward from the transporting carriage (wherein the direction of emission of the light beam may be sequentially switched over). In this occasion, the selecting device controls the monitoring device to (i) monitor in the direction of emission of the light beam which is emitted forward in the traveling direction of the transporting carriage, in case that the transporting carriage is traveling, and (ii) monitor in the direction of emission of the light beam which is emitted downward from the transporting carriage, in case that the gripping mechanism is moved down. Accordingly, by virtue of just one sensor, the detection of an obstacle possibly existing forward in the traveling direction can be performed when the transporting carriage is traveling, and the detection of an obstacle possibly existing downward from the transporting carriage can be performed when the gripping mechanism is moved down. Therefore, it is possible to realize the detection of an obstacle forward in the traveling direction and the detection of an obstacle downward from the transporting carriage at low cost.

In one aspect of the present inventions said selecting device establishes said one or another condition by selecting the area of monitoring without changing the direction of emission.

According to this aspect, it is possible to realize both of the monitoring forward in the traveling direction and the monitoring downward, without the necessity of changing the direction of emission of the light beam.

In another aspect of the present invention, the pseudo plane surface is not overlapping on a path of said gripping mechanism moved down by said hoisting mechanism.

According to this aspect, the detection downward can be realized by employing the pseudo plane surface, which is not overlapping on the path of the gripping mechanism moved down. The pseudo plane surface may be preferably positioned in the vicinity of or adjacent to the path of the gripping mechanism moved down.

In this aspect, the pseudo plane surface may be positioned on an opposite side of a main body of a manufacturing or processing apparatus having the load port, with respect to the path of said gripping mechanism.

By constructing in this manner, the obstacle possibly existing on the opposite side (e.g., the near side in the embodiment) of the path of the gripping mechanism can be certainly monitored. Especially, it is possible to avoid the gripping mechanism or the FOUP itself from being detected as the obstacle in the downward monitoring areas even if the downward monitoring is continued during the downward movement of the gripping mechanism. In other ward, it is possible to perform the downward monitoring not only before the movement but also during the movement of the gripping mechanism moved down. Further, the downward monitoring area can be substantially minimized and the downward monitoring can be simply and easily performed since the whole area where the gripping mechanism passes through is not required to be monitored.

In another aspect of the present invention, said sensor emits the light beam for scanning within the pseudo plane surface, and said selecting device selects a scanning area of the emitted light beam by said sensor or selects a monitoring area by said monitoring device without changing the scanning area.

According to this aspect, the selecting device controls the sensor as following. Namely, in case that the transporting carriage is traveling, the scanning area is positioned forward in the traveling direction of the transporting carriage. In case that the gripping mechanism is moved down, the scanning area is positioned downward from the transporting carriage. In either case, the monitoring device monitors in the scanning area. Alternatively, the scanning area includes the forward traveling direction of the transporting carriage and the downward from the transporting carriage. In this occasion, the selecting device controls the monitoring device to (i) monitor in the scanning area forward in the traveling direction of the transporting carriage, in case that the transporting carriage is traveling, and (ii) monitor in the scanning area downward from the transporting carriage, in case that the gripping mechanism is moved down. Accordingly, it is possible to monitor a broader or wider range as compared with the case that the monitoring device monitors in the direction of emission of the light beam emitted just in one direction.

In this aspect related to the scanning area, said monitoring device may monitor the obstacle in a path where said transporting carriage passes through, within the scanning area, in case that said transporting carriage is traveling.

By constructing in this manner, it is possible to avoid an object for detection from being erroneously detected as the obstacle, which exists out of the path of the transporting carriage when the transporting carriage is traveling.

In this aspect related to the scanning area, said monitoring device may monitor the obstacle in a path where said gripping mechanism is moved down, within the scanning area, in case that said gripping mechanism is moved down.

By constructing in this manner, it is possible to avoid an object for detection from being erroneously detected as the obstacle, which exists out of the path of the gripping mechanism when the gripping mechanism is moved down.

The nature, utility, and further features of this invention will be more clearly apparent from the following detailed description with respect to preferred embodiments of the invention when read in conjunction with the accompanying drawings briefly described below.

### BRIEF DESCRIPTION OF THE DRAWINGS

FIG. 1 is a perspective view of an OHT system carrying a FOUP, together with a semiconductor manufacturing apparatus, in an embodiment of the present invention;

FIG. 2 is a front view of a transporting carriage of the OHT system shown in FIG. 1, from the forward in the traveling direction of the transporting carriage;

FIG. 3 is a block diagram of a sensor shown in FIG. 1 and a sensor controlling portion for controlling the sensor;

FIG. 4 is a left side view (i.e., the near side view) of the transporting carriage of FIG. 2; and

FIG. 5 is a flowchart showing procedures performed by the sensor controlling portion.

### DETAILED DESCRIPTION OF THE PREFERRED EMBODIMENTS

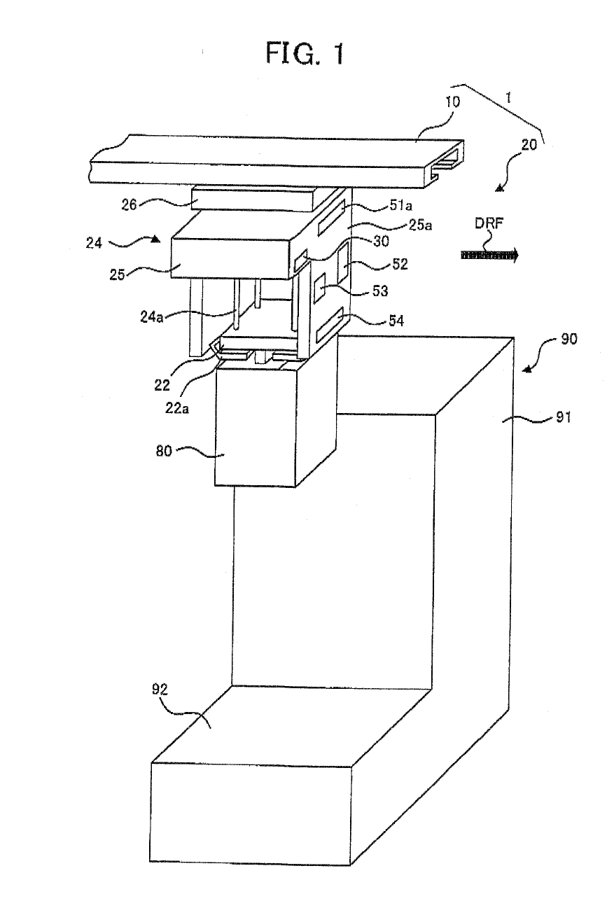

Referring to the accompanying drawings, an embodiment of the present invention will be now explained FIG. 1 shows an overall structure of an OHT (Overhead Hoist Transport) system 1, as one example of the overhead traveling and transporting apparatus of the embodiment of the present invention.

As shown in FIG. 1, the OHT system 1 is a transporting system or apparatus for transporting a FOUP 80 in which semiconductor wafers are contained, in a manufacturing facility for a semiconductor device. The OHT system 1 is provided with: a track 10 which is installed on or beneath the ceiling of the manufacturing facility; and a transporting carriage 20 which travels while holding the FOUP 80 in such a manner that the transporting carriage 20 is suspended and guided by the track 10 in a suspended condition. Nearly beneath the track 10, a main body 91 of a semiconductor manufacturing apparatus 90 among a plurality of semiconductor manufacturing apparatuses (e.g., wafer processing apparatus, a stocker or stacker device and the like) in the manufacturing facility, just one of which is illustrated in FIG. 1. A load port 92, which is a place for loading and retrieving (i.e., unloading) the FOUP 80 and which becomes a place for transition or relay where the operations of taking in or taking out the semiconductor wafers in the FOUP 80, into or from the main body 91 of each of the semiconductor manufacturing apparatuses are performed, is positioned right beneath the track 10.

The transporting carriage 20 is provided with a gripping mechanism 22, a hoisting mechanism (i.e., a moving up and down mechanism) 24, and a position adjusting mechanism 26. The gripping mechanism 22 is constructed to grip or hold the FOUP 80 by a gripper 22a. The hoisting mechanism 24 is constructed to wind off (i.e., send away) or wind up (i.e., hoist) a suspension belt 24a, to the tip of which the gripping mechanism 22 is attached. The position adjusting mechanism 26 is constructed to move the hoisting mechanism 24 in a horizontal plane, with a case 25 of the hoisting mechanism 24.

In the embodiment, the case 25 of the hoisting mechanism 24 has an external shape of an approximately rectangular parallelepiped as illustrated in FIG. 1. More concretely, the upper portion of the case 25 is surrounded by four side surfaces which are perpendicular, while the lower portion of the case 25 is surrounded by two side surfaces which correspond to forward and backward in the traveling direction (which is the direction illustrated by an arrow DRF in FIG. 1) of the transporting carriage 20. As compared with the lower portion of the case 25, the upper portion of the case 25 surrounded by the four side surfaces is slightly projected on the opposite side (hereinbelow it is referred to as a “near side”) of the main body 91 with respect to the track 10.

In FIG. 1, the condition that the suspension belt 24a is wound off halfway is illustrated. In the embodiment, in case that the gripping mechanism 22 is gripping the FOUP 80, when the suspension belt 24a is winding up to the uppermost portion, the FOUP 80 is accommodated in a space surrounded by the case 25.

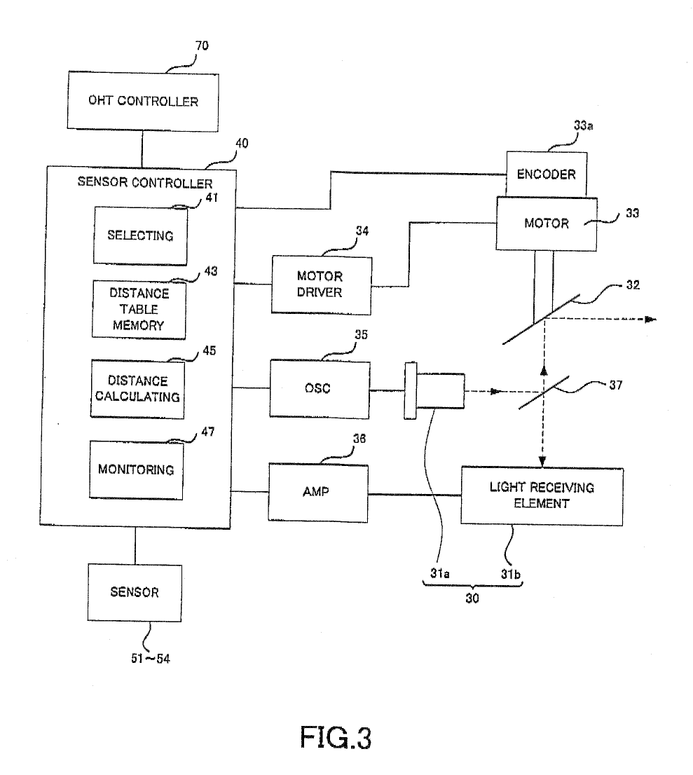

By the above mentioned structure, in the OHT system 1, the transporting carriage 20 supported by the track 10 travels between a plurality of semiconductor manufacturing apparatuses 90. The retrieving (i.e., unloading) operation of the FOUP 80 from the load port 92 and the loading operation of the FOUP 80 onto the load port 92 are performed. More concretely, in case that the transporting carriage 20 gripping the FOUP 80 by the gripping mechanism 22 is to load the FOUP 80 onto the load port 92 of the destination semiconductor manufacturing apparatus 90, (i) the transporting carriage 20 is stopped above the pertinent load port 92, (ii) the load position is finely adjusted as the position adjusting mechanism 26 performs the positional adjustment between the gripping mechanism 22 and the load port 92, (iii) the suspension belt 24a, which has been winding up to the uppermost portion, is successively winding off, and (iv) the FOUP 80 is send down to the load port 92. Then, the gripping mechanism 22 opens the gripper 22a, so as to load the FOUP 80 on the load port 92. After this loading operation for the FOUP 80 is finished, the suspension belt 24a is wound up. When the gripping mechanism 22 reaches the uppermost portion, the transporting carriage 20 starts to travel to the next destination. Incidentally, the traveling operation of the transporting carriage 20 and the retrieving and loading operations for the FOUP 80 are controlled by the OHT controller 70 (refer to FIG. 3).

The transporting carriage 20 is also provided with five sensors 30 and 51 to 54, each of which is a reflection type sensor. These sensors 30 and 51 to 54 are controlled by a sensor controller 40 (refer to FIG. 3). As shown in FIG. 1, the sensor 30 is disposed at the lower end on the front i.e., forward in the traveling direction of a projected portion of the upper portion of the case 25, which is projected to the near side. The sensors 51 to 54 are disposed on a surface 25a of the case 25 on the front i.e., forward in the traveling direction of the transporting carriage 20. More concretely, the sensors 51 and 54 are respectively disposed near the upper portion of the surface 25a and near the lower portion of the surface 25a. The sensor 52 is disposed near the end portion on the side of the semiconductor manufacturing apparatus 90 with respect to the width direction of the surface 25a (i.e., on the opposite side of the “near side” with respect to the track 10, which will be referred to as the “far side” hereinbelow). The sensor 53 is disposed near the end portion on the near side of the lower portion of the surface 25a.

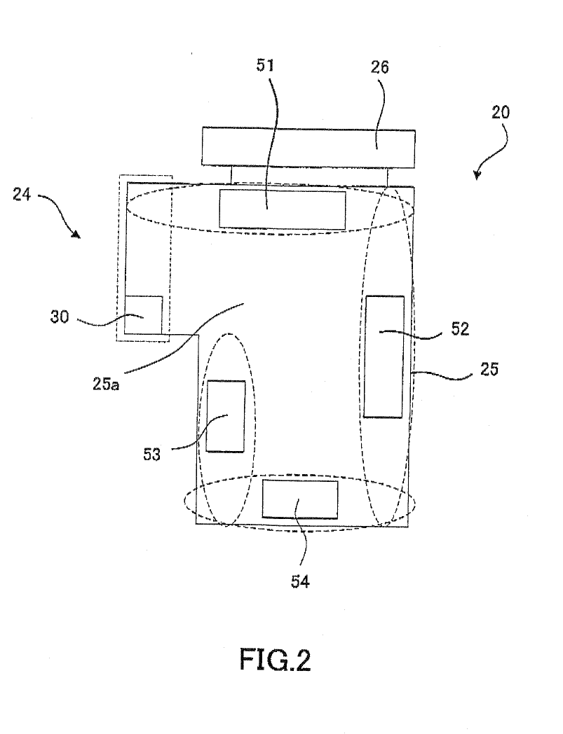

Here, with referring to FIG. 2, which is a front view of the transporting carriage 20 seeing from the forward in the traveling direction thereof, the four sensors 51 to 54 disposed on the surface 25a will be described in more detail. Each of the sensors 51 to 54 is provided with (i) a light emitting element (not illustrated), which emits a light beam forward in the traveling direction of the transporting carriage 20 and (ii) a light receiving element (not illustrated), which receives the reflection light, so that the object for detection can be detected as an obstacle within the area or space of emission of the emitted light beam. The light beam emitted from each of the sensors 51 to 54 spreads in a circular cone shape by passing through a lens (not illustrated) or the like.

The irradiation range of the light beam emitted from each of the sensors 51 to 54 becomes an area surrounded by respective one of the broken lines in FIG. 2. Namely, each of the light beams emitted from the sensors 51 and 54 disposed near the upper end portion and the lower end portion respectively, is an elongated circular cone, which is elongated in the width direction of the transporting carriage 20 (i.e., the left and right direction in FIG. 2). The length of the irradiation area along the width direction of the transporting carriage 20 is substantially coincident with the length of the upper side and the lower side of the surface 25a respectively. Each of the light beams emitted from (i) the sensor 52 disposed near the end portion on the far side (i.e., right in FIG. 2) of the surface 25a and (ii) the sensor 53 disposed near the end portion on the near side (i.e., left in FIG. 2) of the lower portion of the surface 25a is an elongated circular cone, which is elongated in the up and down direction of the transporting carriage 20. The length of the irradiation area of the sensor 52 along the up and down direction is substantially coincident with the length of the side of the surface 25a on the far side. The length of the irradiation area of the sensor 53 along the up and down direction is substantially coincident with the length of the side of the surface 25a at the lower portion thereof on the near side.

Therefore, as shown in FIG. 2, the areas of emissions by the sensors 51 to 54 become portions of the peripheral area of the surface 25a, which is the front surface in the traveling direction of the transporting carriage 20, except for the near side of the upper portion of the surface 25a (i.e., except for the left upper portion of the peripheral area of the surface 25a in FIG. 2).

Next, with referring to FIG. 3, the sensor 30 will be explained in detail. As shown in FIG. 3, the sensor 30 is provided with a light emitting element 31a for emitting a laser light beam and a light receiving element 31b for receiving the reflection light. The laser light beam emitted from the light emitting element 31a is reflected by a half mirror 37, and is guided to the reflection mirror 32. The reflection light, which is reflected by the object for detection after emitted from the light emitting element 31a, is transmitted through the half mirror 37 and is guided to the light receiving element 31b.

The refection mirror 32 is adapted to be rotated or swung by a motor 33, which is driven by a motor driver 34, so that the laser light beam emitted from the light emitting element 31a is scanned by the rotation or swing of the mirror 32. Namely, the sensor 30 is a scanning type sensor. Further, the motor 33 is equipped with an encoder 33a, which detects the rotation amount of the motor 33, so that the angle of the reflection mirror 32 i.e., the direction or angle of emission of the laser light beam reflected by the reflection mirror 32 can be detected by the output value of the encoder 33a.

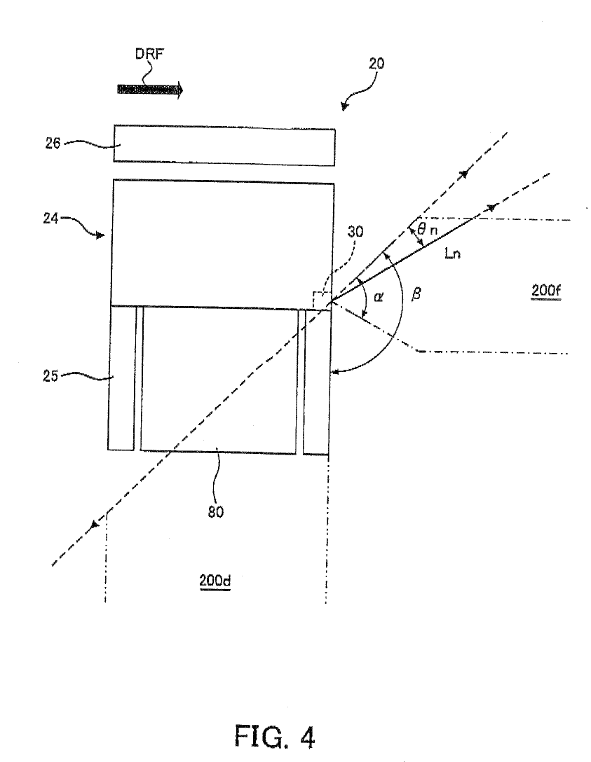

Here, with referring to FIG. 4 which shows the transporting carriage 20 from the near side, the scanning range of the sensor 30 will be explained in detail. The sensor 30 emits the light beam within a pseudo plane surface. The pseudo plane surface is perpendicular and in parallel with the traveling direction of the transporting carriage 20 and is positioned on the near side nearer than the path of the gripping mechanism 22, which is moved up and down by the hoisting mechanism 24. In the embodiment, as shown in FIG. 4, the light beam emitted from the sensor 30 is scanned in the range of 180 degrees including forward and downward in the traveling direction (i.e., the direction indicated by the arrow DRF in FIG. 4) of the transporting carriage 20. Namely, the light beam emitted from the sensor 30 in the right-upward direction in FIG. 4 is scanned by 180 degrees clockwise until the position where the light beam is emitted in the left-downward direction in FIG. 4. After that, the emitted light beam is scanned by 180 degrees counter-clockwise until the position where the light beam is emitted in the right-upward direction in FIG. 4. The sensor 30 repeats such a scanning operation repeatedly without ceasing while the transporting carriage 20 is traveling. In the explanation blow, the angle of the light beam from the uppermost direction as a standard direction, which is the right-upward position in FIG. 4 is referred to as the “emitting angle” θ.

Then, under the control of the sensor controller 40 described later in detail, when the transporting carriage 20 is traveling, such a condition is established that an obstacle in the path (which is sandwiched between two of horizontal dashed-one-dotted lines in FIG. 4 and will be referred to as “forward monitoring area 200f”) where the transporting carriage 20 is passing within the scanning area is monitored by the sensor 30. On the other hand, when the gripping mechanism 22 is moved down to the load port 92 by virtue of the hoisting mechanism 24, such a condition is established that an obstacle in an area along the path where the gripping mechanism 22 is moving up and down within the scanning area, i.e. in more detail, an area (which is sandwiched between two of vertical dashed-two-dotted lines in FIG. 4 and will be referred to as “downward monitoring area 200d”) below the projected portion, which is projected toward the near side of the upper portion of the case 25 is monitored by the sensor 30. Incidentally, the emitting angle θ of the light beam emitted to the forward monitoring area 200f is 0 deg≦θ≦α. The emitting angle θ of the light beam emitted to the downward monitoring area 200d is β≦θ≦180 deg.

As shown in FIG. 2, the forward monitoring area 200f (in FIG. 4) corresponds to the neighborhood of the end or edge portion on the near side (i.e., the left side in FIG. 2) of the upper portion of the surface 25a of the case 25. The length in the up and down direction of the forward monitoring area 200f of the sensor 30 is approximately coincident with the length of the side of the upper portion of the surface 25a on the near side. As already mentioned, the areas of emissions by the sensors 51 to 54 equipped on the surface 25a are the neighborhood of the peripheral end or edge portion of the surface 25a, except for the upper portion on the near side. Therefore, by the irradiation areas of the sensors 51 to 54 together with the forward monitoring area 200f of the sensor 30, it is possible to detect an obstacle as for substantially all areas in the vicinity of the peripheral end or edge portion of the surface 25a i.e., the passing area of the transporting carriage 20.

In FIG. 3 again, the light emitting element 31a is connected to an oscillation circuit (OSC) 85 and is adapted to emit a high frequency pulse light on the basis of a high frequency pulse signal supplied from the oscillation circuit 35. The light receiving element 31b is connected to an amplifier (AMP) 86 such that an output signal related to the reflection light received by the light receiving element 31b is amplified by the amplifier 36.

Hereinbelow, the sensor controller 40 which controls the sensor 30 and the sensors 51 to 54 will be explained with referring to FIG. 3. As shown in FIG. 3, the sensor controller 40 is connected with the OHT controller 70, the encoder 33a, the motor driver 34, the oscillation circuit (OSC) 35, the amplifier (AMP) 36, and the sensors 51 to 54. The sensor controller 40 is provided with a selecting unit 41, a distance table memory unit 43, a distance calculating unit 45 and a monitoring unit 47.

The selecting unit 41 controls the sensor 30 and the sensors 51 to 54, on the basis of the information related to the traveling of the transporting carriage 20, which is transmitted from the OHT controller 70. More concretely, while the information indicating that the transporting carriage 20 is traveling is transmitted from the OHT controller 70, the forward monitoring area 200f is selected as the area to be monitored by the sensor 30. Such a condition is established that the neighborhood of the peripheral end or edge portion of the area (which includes the forward monitoring area 200f) where the transporting carriage 20 is passing, is monitored by the sensor 30 and the sensors 51 to 54. On the other hand, when the information indicating that the transporting carriage 20 is being stopped and that the retrieving or loading operation for the FOUP 80 is being performed is transmitted, the downward monitoring area 200d is selected as the area to be monitored by the sensor 30. Such a condition is established that the near side of the path of the gripping mechanism 22 which is moving up and down (i.e., the downward monitoring area 200d) is monitored by the sensor 30.

In the distance table memory unit 43, a distance table correlating the emitting angle θi of the light beam emitted from the sensor 30 with the monitored distance Li is stored, Namely, as shown in FIG. 4, in case that the light beam is emitted within the forward monitoring area 200f and that the emitting angle is θn for example, the distance Ln through which the light beam emitted by this emitting angle θn passes within the forward monitoring area 200f is stored as the monitored distance Ln. In the same manner, the monitored distance is stored, which corresponds to the emitting angle of the light beam emitted within the downward monitoring area 200d. On the other hand, in case that the light beam is emitted to the area, which is not the forward monitoring area 200f or the downward monitoring area 200d, namely in case of α<θi<β, the monitored distance Li is stored as 0 (zero).

Here, the maximum value of the monitored distance Li in case that the light beam is emitted within the forward monitoring area 200f is set to be more than the length required for the transporting carriage 20, which is in the traveling condition, to stop. On the other hand, the maximum value of the monitored distance Li in case that the light beam is emitted within the downward monitoring area 200d is set to be slightly shorter than the length from the sensor 30 to the load port 92. In case that the length from the sensor 30 to the load port 92 is different for each semiconductor manufacturing apparatus 90, the maximum value of the monitored distance Li for the downward monitoring area 200d is set for each semiconductor manufacturing apparatus 90. The information indicating to which semiconductor manufacturing apparatus 90 the retrieving and/or the loading operation for the FOUP 80 is to be performed is obtained from the OHT controller 70, and the maximum value of the monitored distance Li is determined in response to the obtained information.

The distance calculating unit 45 calculates the distance to the object for detection in case that the object for detection is detected by the sensor 30. More concretely, the pulse signal supplied from the oscillation circuit 35 to the light emitting element 31a and the output signal from the light receiving signal, which is amplified by the amplifier 36, are compared with each other. Then, the distance L to the object to be detected is calculated on the basis of the phase difference, which is generated in the output signal of the light receiving element 31b in accordance with the reciprocation distance of the light beam emitted from the light emitting element 31a and reflected by the object for detection.

The monitoring unit 47 monitors an obstacle within the monitoring areas (i.e., the forward monitoring area 200f and the downward monitoring area 200d) of the sensor 30 and/or the irradiation areas of the sensors 51 to 54, on the basis of the reflection lights received by the sensor 30 and the sensors 51 to 54. Here, for example, it is assumed that the sensor 30 detects the object for detection when the monitoring area of the sensor 30 is the forward monitoring area 200f and when the emitting angle of the emitted light beam is θn (refer to FIG. 4). On this assumption, the monitoring unit 47 compares (i) the distance L to the object for detection which is calculated by the distance calculating unit 45 and (ii) the monitoring distance Ln for the emitting angle θn which is stored in the distance table memory unit 43 with each other. Then, if the distance L is longer than the monitoring distance Ln, it is judged that the object for detection is out of the forward monitoring area 200f i.e., no obstacle exists within the forward monitoring area 200f. On the other hand, if the distance L is not longer than the monitoring distance Ln, it is judged that the object for detection is within the forward monitoring area 200f i.e., an obstacle exists within the forward monitoring area 200f, which would become the obstacle for the traveling of the transporting carriage 20. In case that the light amount of one or plurality of the reflection lights received by the sensors 51 to 54 exceeds a predetermined values it is judged that an obstacle exists within the irradiation areas of the sensors 51 to 54.

Incidentally, if it is judged by the monitoring unit 47 that the obstacle exists within the monitoring area of the sensor 30 and/or the irradiation areas of the sensors 51 to 54, the detection signal indicating the existence of the obstacle is transmitted to the OHT controller 70.

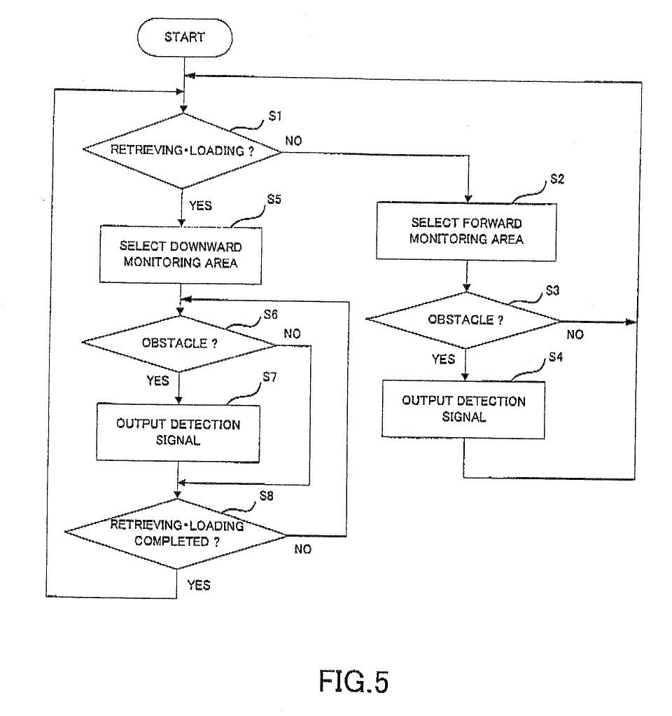

Next, the procedures performed by the sensor controller 40 will be explained with referring to FIG. 5. The processing of the sensor controller 40 is consistently performed while the transporting carriage 20 is traveling.

In FIG. 5, at first, it is judged whether the transporting carriage 20 performs or does not perform the retrieving operation (i.e., the unloading operation) of the FOUP 80 from the load port 92 or the loading operation of the FOUP 80 onto the load port 92, on the basis of the information transmitted from the OHT controller 70 (step S1). If it is judged that the transporting carriage 20 does not perform the retrieving or loading operation (step S1: NO), the selecting unit 41 selects the forward monitoring area as the area to be monitored by the sensor 30, and establishes such a condition that the sensor 30 and the sensors 51 to 54 monitor the obstacle (step S2). Then, on the basis of the output signals of the sensor 30 and the sensors 51 to 54, it is judged whether an obstacle exists or not in the neighborhood of the peripheral portion of the area where the traveling transporting carriage 20 passes through (step S3).

If it is judged that the obstacle does not exist (step S3: NO), the flow returns back to the step S1, so that the judgment as for the performance of the retrieving or loading operation is performed again. On the other hand, if it is judged that the obstacle exists (step S3: YES), the detection signal to inform the existence of the obstacle to the OHT controller 70 is outputted (step S4). In this occasion, the OHT controller 70 controls the transporting carriage 20 to slow down or stop. Accordingly, it is possible to prevent one transporting carriage 20 from crashing with another transporting carriage 20, even if another transporting carriage 20 is being stopped forward in the traveling direction of one transporting carriage 20 or the like. Incidentally, after the detection signal is outputted at the step S4, the flow returns back to the step S1, so that the judgment as for the performance of the retrieving or loading operation is performed again.

Furthers at the step S1, if it is judged that the retrieving or loading operation is performed (step S1: YES), the selecting unit 41 selects the downward monitoring area as the area to be monitored by the sensor 30 (step S5). Then, on the basis of the output signal of the sensor 30, it is judged whether an obstacle exists or not on the near side of the path of the gripping mechanism 22 moving up and down (step S6).

Here, if it is judged that the obstacle does not exist (step S6: NO), the procedure at a step S7 described later is omitted and the flow directly proceeds to a step S8. On the other hand, if it is judged that the obstacle exists (step S6: YES), the detection signal to inform the existence of the obstacle to the OHT controller 70 is outputted (step S7). In this occasion, the OHT controller 70 controls the gripping mechanism 22 to stop moving down. Accordingly, it is possible to prevent the FOUP 80 from contacting or crashing a human-being or the like, even if the human-being or the like enters beneath the gripping mechanism 22, which is about to move down while gripping the FOUP 80. Incidentally, as in the present embodiment, it is possible to perform monitoring efficiently, by monitoring the near side of the place where such a possibility is high that an obstacle may come closest to the path of the gripping mechanism moving up and down.

After that, on the basis of the information transmitted from the OHT controller 70, it is judged whether the retrieving or loading operation of the transporting carriage 20 is completed or not (step S8). Here, if it is judged that the retrieving or loading operation is not completed yet (step S8: NO), the flow returns back to the step S6, so that it is judged again whether an obstacle exists or not in the downward monitoring area. On the other hand, if it is judged that the retrieving or loading operation is completed (step S8: YES), the flow returns back to the step S1, so that the judgment as for the performance of the retrieving or loading operation is performed again.

As described above, in the OHT system 1 of the present embodiment, the sensor equipped on the transporting carriage 20 emits the light beam within the pseudo plane surface, which is perpendicular and in parallel with the traveling direction of the transporting carriage 20 and is positioned on the near side nearer than the path of the gripping mechanism 22, which is moved up and down by the hoisting mechanism 24. Further, under the control of the selecting unit 41, when the transporting carriage 20 is traveling, the forward monitoring area to monitor forward in the traveling direction of the transporting carriage 20 is selected as the monitoring area of the sensor 30. Furthermore, when the retrieving operation of the FOUP 80 from the load port 92 or the loading operation of the FOUP 80 onto the load port 92 is performed, the downward monitoring area to monitor downward from the transporting carriage 20 is selected as the monitoring area of the sensor 30. Therefore, it is not necessary to equip one sensor to monitor the forward monitoring area and another sensor to monitor the downward monitoring area, separately. Namely, it is possible to monitor those two areas by use of just one sensor i.e., the sensor 30. Thus, it is possible to realize (i) the detection of the obstacle forward in the traveling direction of the transporting carriage 20 and the detection of the obstacle downward from the transporting carriage 20 at low cost.

In the OHT system 1 of the present embodiment, the sensor 30 is the scanning type sensor. The selecting unit 41 selects the monitoring area of the monitoring unit 47 among the forward monitoring area and the downward monitoring area, which are included in the scanning area of the sensor 30. Therefore, the monitoring unit 47 can monitor a wider range as compared with the case of monitoring the direction of the emission of the light, which is emitted just on one direction for example.

Further, in the OHT system 1 of the present embodiment, the monitoring unit 47 monitors the neighborhood of the peripheral portion of the area where the transporting carriage 20 passes through, when the transporting carriage 20 is traveling. Therefore, it is possible to prevent an object, which is out of the path of the transporting carriage 20, from being erroneously detected as the obstacle.

In addition, in the OHT system 1 of the present embodiment, the monitoring unit 47 monitors the area along the path of the griping mechanism moving up and down, among the scanning area of the sensor 30, when the transporting carriage 20 is performing the retrieving or loading operation of the FOUP 80. Therefore, it is possible to prevent an object, which is out of the path of the gripping mechanism moving up and down, from being erroneously detected as the obstacle.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

For example, in the above described embodiment, the sensor 30 is consistently scanning within the range including the forward monitoring area and the downward monitoring area while the traveling carriage 20 is traveling, and the selecting unit 41 selects the area to be monitored by the monitoring unit 41 among the forward monitoring area and the downward monitoring area. However, the present invention is not limited to this. Namely, the selecting unit 41 may select the scanning area of the sensor 30, by controlling the motor driver 34. More concretely, when the transporting carriage 20 is traveling, the selecting unit 41 controls the motor driver 34 so that the sensor 30 may perform the scan in the range of 0 deg≦θ≦α. The monitoring unit 47 monitors the obstacle within the area where the traveling carriage 20 passes through, among the scanning area of the sensor 30. On the other hand, when the transporting carriage 20 is performing the retrieving or loading operation, the selecting unit 41 controls the motor driver 34 so that the sensor 30 may perform the scan in the range of β≦θ≦180 deg. The monitoring unit 47 monitors the obstacle within the area along the path of the gripping mechanism moving up and down, among the scanning area of the sensor 30.

In the above described embodiment, the sensor 30 is the scanning type sensor which performs scanning in the range of 180 deg. However, the present invention is not limited to this. The scanning range of the sensor 30 is not limited to the range of 180 deg but may be any other range as long as it can cover the forward monitoring area and the downward monitoring area. Further, the sensor 30 is not necessarily the scanning type sensor but may be any other type as long as it can emit the light beam forward in the traveling direction and downward from the transporting carriage 20.

In the above described embodiment, when the transporting carriage 20 is traveling, the monitoring unit 47 monitors the neighborhood of the peripheral portion of the area where the transporting carriage 20 passes through. By this, the forward monitoring area 200f can be substantially minimized and the forward monitoring can be simply and easily performed since the whole area where the transporting carriage 20 passes through is not required to be monitored. However, the present invention is not limited to this. For example, the monitoring unit 47 may monitor the whole area where the transporting carriage 20 passes through. Further, the monitoring unit 47 may monitor an area, which is slightly broader or wider than the area where the transporting carriage 20 passes through.

In addition, in the above described embodiment, the monitoring unit 47 monitors the area along the path of the gripping mechanism 22 moving up and down, among the scanning area of the sensor 30, when the transporting carriage 20 is performing the retrieving or loading operation. However, the present invention is not limited to this. The monitoring area at the time of the retrieving or loading operation may be an area in a sector form, whose center is the sensor 30.

In the above described embodiment, the OHT system 1 is installed in the semiconductor manufacturing facility, which manufactures the semiconductor devices by applying processes to the semiconductor wafers. However, the present invention is not limited to this. For example, the transporting apparatus may be installed in a facility, which produces final products by applying processes while transporting the processed object or the object to be processed, in the processes or between the processes. Further, the transporting apparatus may be adapted to transporting apparatuses for all categories of industries, in which the transported objects, such as electronic parts, mechanical parts, chemical products, food products, document products and the like, are transported.

The entire disclosure of Japanese Patent Application No. 2006-323197 filed on Nov. 30, 2006 including the specification, claims, drawings and summary is incorporated herein by reference in its entirety.

What is claimed is:

1. An overhead traveling and transporting system comprising:
a track installed on or near a ceiling;
a transporting carriage for traveling along and being guided by said track, having (i) a gripping mechanism adapted to grip a transported object, (ii) a hoisting mechanism adapted to move down said gripping mechanism to a load port for the transported object, and (iii) a sensor for emitting a light beam within a pseudo plane surface, which is perpendicular and in parallel with a traveling direction of said transporting carriage, and for receiving a reflection light of the emitted light beam;
a monitoring device for monitoring an obstacle existing in a direction of emission of the emitted light beam, on the basis of the reflection light received by said sensor; and
a selecting device for (i) establishing one condition that the obstacle existing forward in the traveling direction is monitored by said monitoring device if said transporting carriage is traveling and (ii) establishing another condition that the obstacle existing downward from said transporting carriage is monitored by said monitoring device if said gripping mechanism is moved down, by selecting the direction of emission and/or selecting an area of monitoring by said monitoring device.

2. The overhead traveling and transporting system according to claim 1, wherein said selecting device establishes said one or another condition by selecting the area of monitoring without changing the direction of emission.

3. The overhead traveling and transporting system according to claim 1, wherein the pseudo plane surface is not overlapping on a path of said gripping mechanism moved down by said hoisting mechanism.

4. The overhead traveling and transporting system according to claim 3, wherein the pseudo plane surface is positioned on an opposite side of a main body of a manufacturing or processing apparatus having the load port, with respect to the path of said gripping mechanism.

5. The overhead traveling and transporting system according to claim 1, wherein
said sensor emits the light beam for scanning within the pseudo plane surface, and
said selecting device selects a scanning area of the emitted light beam by said sensor or selects a monitoring area by said monitoring device without changing the scanning area.

6. The overhead traveling and transporting system according to claim 5, wherein said monitoring device monitors the obstacle in a path where said transporting carriage passes through, within the scanning area, in case that said transporting carriage is traveling.

7. The overhead traveling and transporting system according to claim 5, wherein said monitoring device monitors the obstacle in a path where said gripping mechanism is moved down, within the scanning area, in case that said gripping mechanism is moved down.
